(19) United States
(12) Patent Application Publication
(10) Pub. No.: US 2017/0335959 A1
(43) Pub. Date: Nov. 23, 2017

(54) GEAR SHIFTING DEVICE FOR VEHICLE

(71) Applicant: Hyundai Motor Company, Seoul (KR)

(72) Inventors: Hyung Wook Cho, Ansi (KR); Young Min Yoon, Suwon (KR)

(21) Appl. No.: 15/256,138

(22) Filed: Sep. 2, 2016

(30) Foreign Application Priority Data
May 17, 2016 (KR) 10-2016-0060248

(51) Int. Cl. F16H 61/24; F16H 59/04

(52) U.S. Cl. CPC F16H 61/24; F16H 59/044; F16H 59/04; F16H 2061/242

(57) ABSTRACT

A method of selecting and shifting with one actuator and a vehicle gear shifting device that performs the same are provided. The device includes a shift guide that has selecting guides disposed between shifting paths for the selecting guides to diagonally face with a selecting path formed between the shifting paths. Additionally, the device includes a selecting guide member that is disposed in a path made by the shift guide and guides a control shaft in a selecting direction by being supported and guided by the selecting guides when the control shaft is moved in a shifting direction.

### CROSS REFERENCE TO RELATED APPLICATION

The present application claims priority to Korean Patent Application No. 10-2016-0060248, filed May 17, 2016, the entire contents of which is incorporated herein for all purposes by this reference.

### BACKGROUND

### Field of the Invention

The present invention relates to a vehicle gear shifting device, and more particularly, to a vehicle gear shifting device that uses one actuator for selecting and shifting of gears.

### Description of the Related Art

Recently, automated manual transmissions that provide driving convenience \of an automatic transmission and the fuel efficiency and high power efficiency of a manual transmission have been developed. An automated manual transmission, which is a system that automatically operates a clutch and shifts gears based on the mechanism of a manual transmission with a clutch, is operated by an actuator driven by hydraulic pressure or a motor.

For example, a selecting actuator for operating a control shaft in a selecting direction and a shifting actuator for operating the control shaft in a shifting direction are used to shift gears. In other words, when the selecting actuator is operated, the control shaft is moved vertically and a shift finger coupled to the control shaft selects one of a plurality of shift lugs. As the shifting actuator is operated and rotates the control shaft, the shift finger moves the selected shift lug in a direction that corresponds to the rotational direction of the control shaft to thus moving a shift rail. Accordingly, a shift fork coupled to the shift rail moves a sleeve, thereby shifting into a desired gear.

However, the existing automated manual transmissions require actuators for selecting and shifting to shift gears, and thus, it is difficult to reduce the number of actuators and the weight and manufacturing costs of the transmissions are increased. In particular, a dual clutch transmission (DCT) requires two actuators, that is, a selecting actuator and a shifting actuator for shifting into odd-numbered gears and even-numbered gears, respectively, and thus, the weight and manufacturing cost of the DCT are further increased.

The foregoing is intended merely to aid in the understanding of the background of the present invention, and is not intended to mean that the present invention falls within the purview of the related art that is already known to those skilled in the art.

### SUMMARY

Accordingly, the present invention has been made keeping in mind the above problems occurring in the related art, and the present invention is intended to propose a vehicle gear shifting device that uses one actuator for selecting and shifting.

According to one aspect of the present invention, a vehicle gear shifting device may include: a shift guide having selecting guides disposed between shifting paths for the selecting guides to diagonally face with a selecting path formed between the shifting paths; and a selecting guide member disposed in a path formed by the shift guide and configured to guide a control shaft in a selecting direction by being supported and guided by the selecting guides when the control shaft is moved in a shifting direction.

The shift guide may have a selecting path formed in the selecting direction of the control shaft and a plurality of shifting paths vertically arranged at a side or at both sides of the selecting path. The selecting guides may be formed in the shape of plates arranged at an angle across the selecting path, and both ends of the selecting guides may be positioned at inlets of two shifting paths orthogonally facing with the selecting path. Additionally, guide grooves through which the selecting guide member passes while being guided by the selecting guides may be formed on inner sides of the shift guide.

Particularly, the guide grooves may be formed in the shape of an arc inside outermost shifting paths facing ends of the selecting guides. Sections may be formed between shifting paths disposed proximate to each other in same directions to separate the shifting paths, and inclined surfaces that are inclined with respect to the shifting paths may be formed at ends of the sections. The inclined surface may protrude toward a center of the selecting path at a middle portion of an end of a corresponding section and may include a first inclined surface and a second inclined surface that are inclined inward the shifting paths adjacent to the corresponding section, at both ends from the middle portion.

The shift guide may be fixed to cover the control shaft, and the selecting guide member may be fixed at a position facing the control shaft to which the shift guide is fixed. The selecting guide member may be fixed to the control shaft, and the shift guide may be fixed along a rotational radius of the selecting guide member while facing the control shaft to which the selecting guide member is fixed. The device may further include a controller configured to determine a shifting path for the selecting guide member to be guided into a shifting path that corresponds to a desired gear stage by the selecting guides, and may be configured to operate the shifting actuator by calculating a stroke amount and a stroke direction of the shifting actuator to follow the determined shifting path.

The controller may further be configured to determine a center of the selecting path by detecting an end of a first shifting path through the selecting guide member by operating the shifting actuator in a first direction and then detecting an end of a second shifting path through the selecting guide member by operating the shifting actuator in a second direction. The controller may be configured to determine the center of the selecting path by calculating a middle position between the end of the first shifting path and the second shifting path. Further, the controller may be configured to determine the position of the selecting guide member in the selecting direction by detecting the end of the second shifting path, moving the selecting guide member toward a selecting guide by operating the shifting actuator, and then detecting an end of the selecting path by alternately operating the shifting actuator in the first direction and the second direction.

The device may further include a sensor disposed in the selecting path, in which the controller may be configured to determine the center of the selecting path using a change in value output when the selecting guide member passes through the sensor in the selecting path from the shifting paths. The device may further include a selecting position sensor disposed on the control shaft, in which the controller may be configured to determine a position of the selecting guide member in the selecting direction based on a position signal from the selecting position sensor that corresponds to a position of the control shaft in the selecting direction.

According to the present invention, since the control shaft may be moved vertically by vertically moving the shift guide with the selecting guide by operating the shifting actuator in the present invention, it may be possible to perform shifting and selecting of the control shaft. Therefore, the number of actuators is reduced, whereby the manufacturing cost and weight of the transmission may be decreased. Further, since only one actuator is used for shifting, noise due to operation of actuators may be decreased.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a diagram showing an exemplary configuration when the present invention is applied to an automated manual transmission (AMT) according to an exemplary embodiment of the present invention;

FIG. 2 is a diagram showing the configuration of a first exemplary embodiment for a combining a control shaft with a gear shifting device according to an exemplary embodiment of the present invention;

FIGS. 3A to 3C are diagrams illustrating the operation and principle of shifting into predetermined gears by an AM according to an exemplary embodiment of the present invention T;

FIGS. 4A to 4C are diagrams illustrating the operation and principle of shifting into predetermined gears by a DCT according to an exemplary embodiment of the present invention;

FIG. 5 is a diagram showing the configuration of a second exemplary embodiment for a combining a control shaft with a gear shifting device according to an exemplary embodiment of the present invention;

FIGS. 6 and 7 are conceptual diagrams showing a first exemplary control configuration for checking the position of a selecting guide member according to an exemplary embodiment of the present invention; and

FIG. 8 is a conceptual diagram showing a second exemplary control configuration for checking the position of a selecting guide member according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Exemplary embodiments of the present invention will be described hereafter in detail with reference to the accompanying drawings.

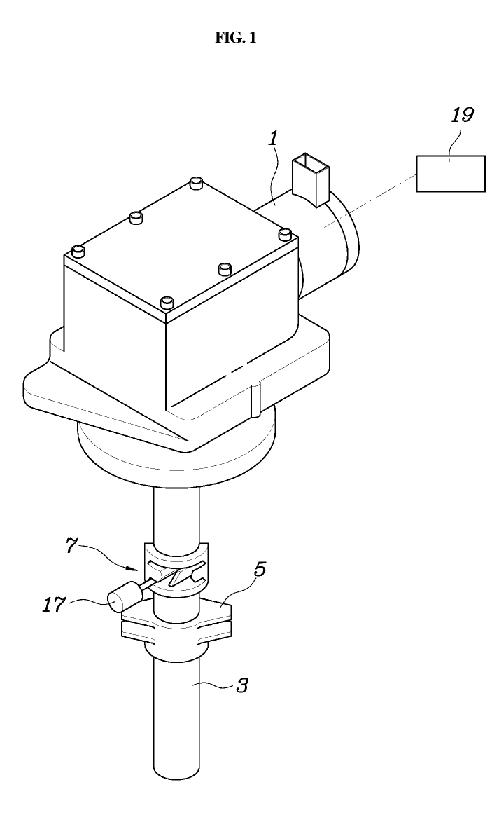

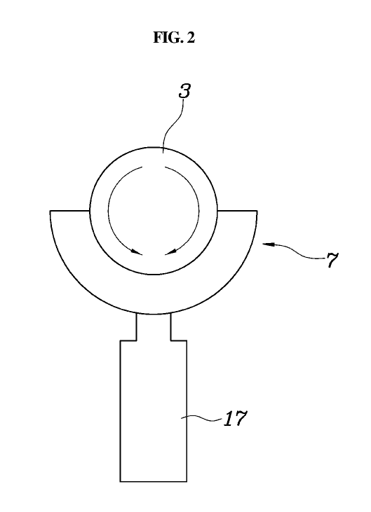

A gear shifting device of the present invention may include a shift guide 7 having selecting guides 15 and a selecting guide member 17. Referring to FIGS. 1 and 2 to describe the present invention in detail, first, the shift guide 7, configured to move with a control shaft 3, may include the selecting guides 15 disposed between two shifting paths 7b for the selecting guides 15 to diagonally face with a selecting path 7a formed between the shifting paths 7b. For example, the shift guide 7 may be fixed directly to the control shaft 3 or to a portion (a shift finger 5) connected to the control shaft 3 to move in a selecting direction and a shifting direction with the control shaft 3. When the shift guide 7 is fixed to the control shaft 3, the shift guide 7 may cover the outer side of the control shaft 3.

The selecting guides 15 may also be fixed in the shift guide 7 to move with the control shaft 3. In particular, the shift guide 7 may have a substantially straight selecting path 7a (e.g., a linear selecting path) formed in the selecting direction of the control shaft 3 and a plurality of shifting paths 7b arranged vertically at a side or both sides of the selecting path 7a. For example, in a 5-speed AMT, three shifting paths 7b are formed respectively at both sides of a selecting path 7a to form shifting paths 7b for shifting into the first to fifth gears and the rear gear.

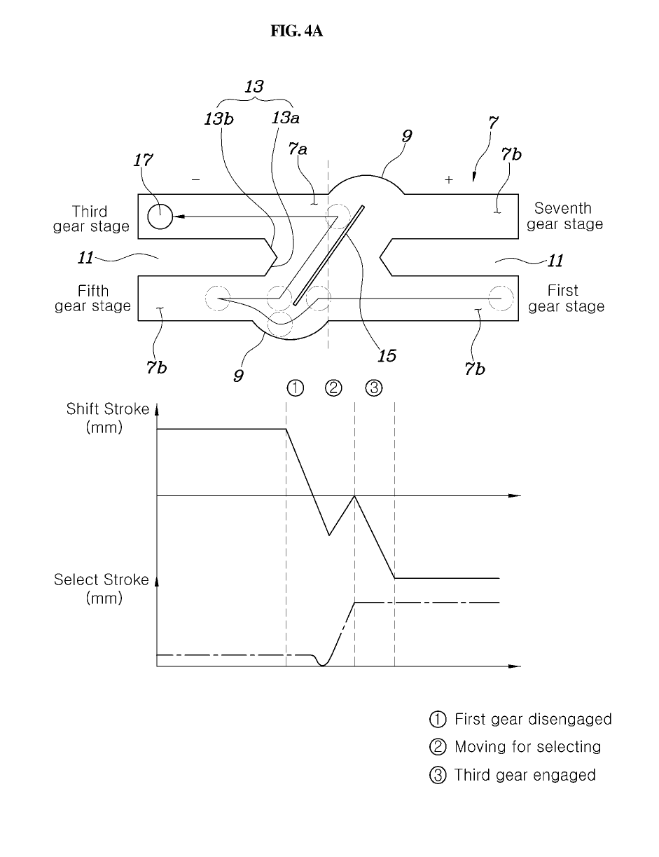

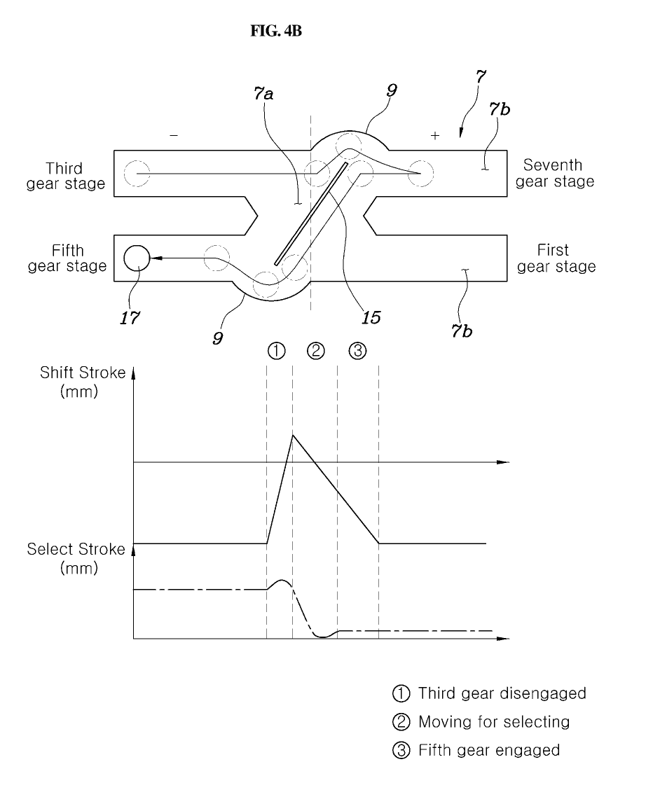

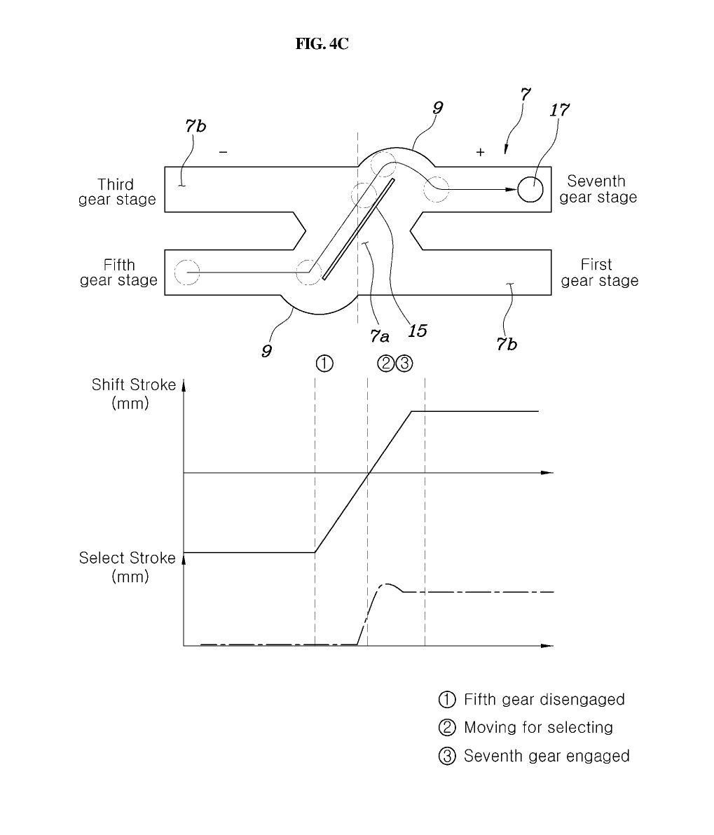

For example, in a 7-speed DCT, as shown in FIG. 4A, two shifting paths 7b may be formed respectively at both sides of a selecting path 7a to form shifting paths 7b for shifting into odd-numbered gears. Though not shown in the figures, a shift guide 7 configured to shift into even-numbered gears may also be provided. In particular, the selecting guides 15 in the shift guide 7 may be formed in the shape of plates arranged at an angle across the selecting path 7a. Both ends of the selecting guides 15 may be positioned at an inlet that extends from the selecting path 7a to the shifting paths 7b.

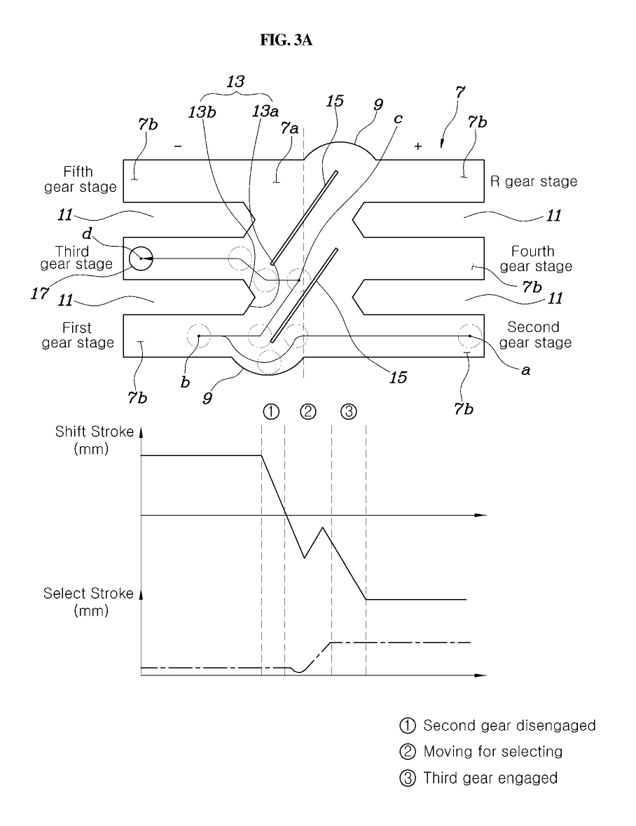

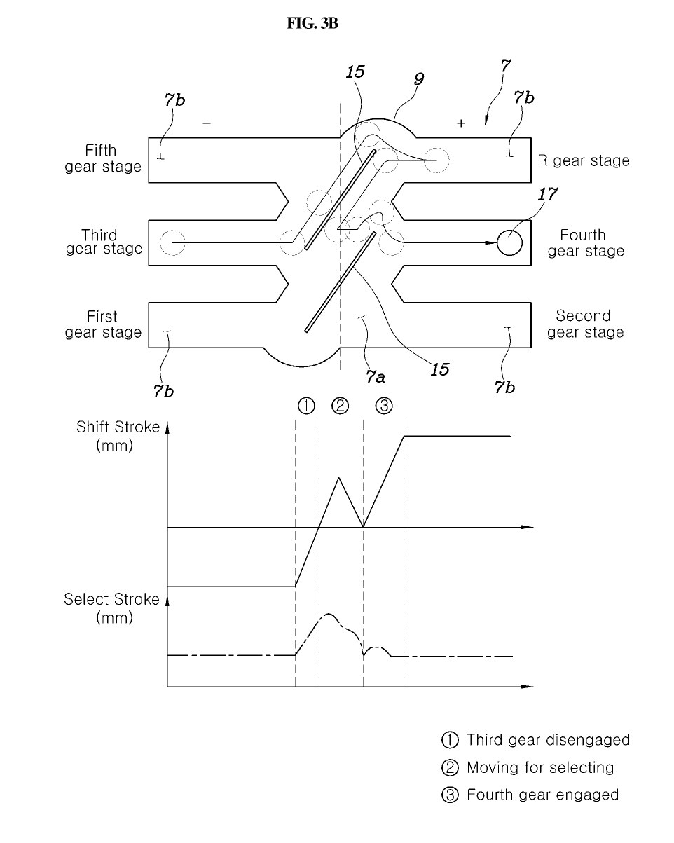

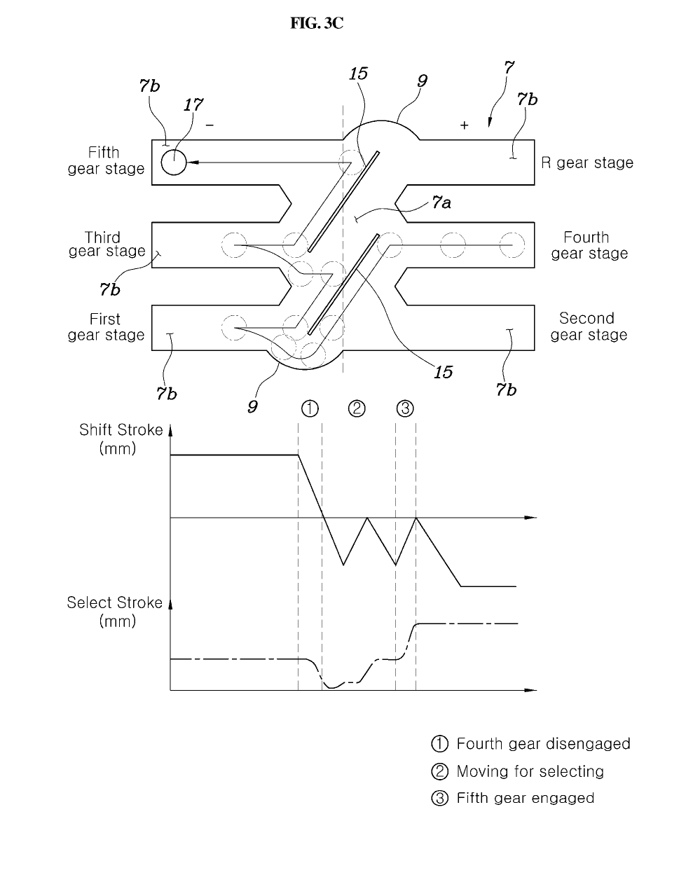

For example, in a 5-speed AMT, as shown in FIG. 3A, a selecting guide 15 may be disposed between the inlet of a shifting path 7b for a first gear stage and the inlet of a shifting path 7b for a fourth gear stage, and a selecting guide 15 may be disposed between the inlet of a shifting path 7b for a third gear stage and the inlet of a shifting path 7b for the R gear stage. In a 7-speed DCT, as shown in FIG. 4A, a selecting guide 15 may be disposed between the inlet of a shifting path 7b for a fifth gear stage and the inlet of a shifting path 7b for a seventh gear stage.

Further, the selecting guide member 17, formed in the shape of a pin, may be disposed with an end positioned (e.g., maintained) in the shifting paths 7b or the selecting path 7a of the shift guide 7. When the control shaft 3 is moved in a shifting direction, the selecting guide member 17 may be supported and guided by the selecting guide 15 to guide the control shaft 3 moving in a selecting direction. For example, the selecting guide member 17 may be disposed to face the shift guide 7 and may be fixed to a transmission case or an actuator housing.

According to this configuration, when a shifting actuator 1 is operated to shift into a gear, the control shaft 3 may be rotated and the shift guide 7 may be correspondingly rotated, in which when the shifting actuator 1 is operated, for example, maintains operation or changes the direction, the selecting guide 15 may be moved in contact with the selecting guide member 17. In other words, as the shifting actuator 1 continuously moves with the selecting guide 15 in contact with the selecting guide member 17 while maintaining the contact therewith, the selecting guide 15 may be moved by the rotational force of the control shaft 3 as the selecting guide member 17 slides over the inclined surface of the selecting guide 15.

Accordingly, the shift guide 7 may be moved vertically with the selecting guide 15 and the control shaft 3 to which the shift guide 7 is fixed may be correspondingly vertically to perform both shifting and selecting of the control shaft 3 by the shifting actuator 1, and accordingly, the number of actuators may be reduced, whereby the manufacturing cost and weight of the transmission may be reduced. Further, since only one actuator is used for shifting, noise due to operation of actuators may be decreased.

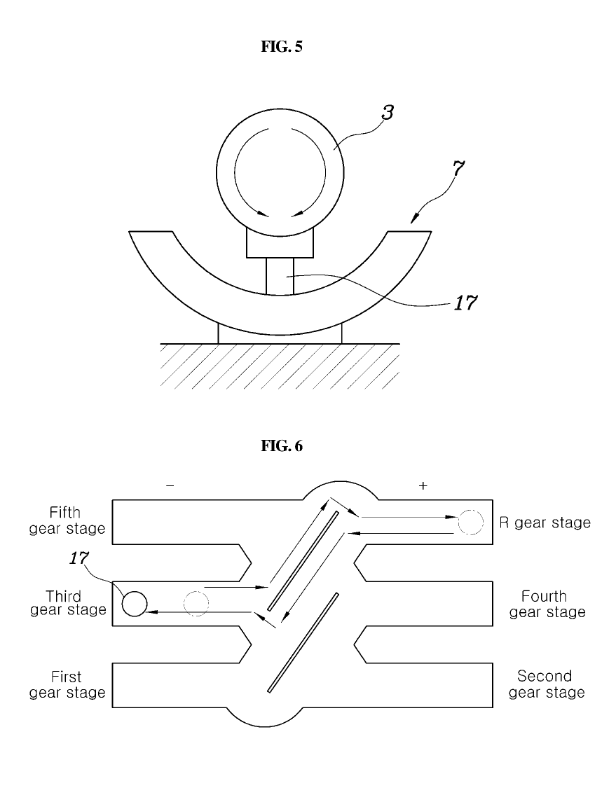

Moreover, FIG. 5 shows another example of arranging the shift guide 7 and the selecting guide member 17, in which the selecting guide member 17 may be configured to move with the control shaft 3 and the shift guide 7 may be fixed to face the control shaft 3. For example, the selecting guide member 17 may be fixed to the control shaft 3 to rotate and move with the control shaft 3. Further, the shift guide 7, which may be fixed along the rotational radius of the selecting guide member 17 while facing the control shaft 3 to which the selecting guide member 17 is fixed, may be fixed to a transmission case or an actuator housing.

However, the arrangement of the shift guide 7 and the selecting guide member 17 exemplified in FIGS. 1 and 2 are described hereafter. Particularly, a plurality of guide grooves 9 through which the selecting guide member 17 may pass when the selecting guides 15 guide the selecting guide member 17 may be formed on the inner side of the shift guide 7 in the present invention. The guide grooves 9 may be formed in the shape of an arc inside the outermost shifting paths 7b facing the ends of the selecting guides 15. In other words, the guide grooves 9 may be formed on the inner sides of the outermost shifting paths 7b of a plurality of shifting paths 7b.

According to this configuration, when the selecting guide member 17 moves off the end of a selecting guide 15 and enters a shifting path 7b, the selecting guide member 17 may pass a guide groove 9 before entering the shifting path 7b, to ensure a sufficient space for the selecting guide member 17 to pass through, whereby the control shaft 3 may be moved more smoothly for performing selecting. Further, sections 11 may be formed between shifting paths 7b disposed proximate to each other in same directions to separate the shifting paths 7b and inclined surfaces that are inclined with respect to the shifting paths 7b may be formed at ends of the sections 11. In other words, referring to FIG. 3A, a section 11 may be formed between the shifting paths 7b for the second and fourth gear stages and an inclined surface 13 may be formed at the end, proximate to the selecting path 7a, of the section 11 by chamfering both sides of the end.

The inclined surface 13 may protrude toward the center of the selecting path 7a at the middle portion of the end of the section 11 and may include two inclined surfaces inclined or sloped inward the shifting paths 7b adjacent to the section 11 between the second and fourth gear stages 7b, at both ends from the middle portion, in which a first inclined surface 13a facing the selecting guide 15 may be inclined to corresponding to the inclination of the selecting guide 15 and a second inclined surface 13b may be inclined symmetrically to the first inclined surface 13a from the middle portion of the inclined surface 13. According to this configuration, when a selecting guide member 17 is moved between the selecting path 7a and the section 11, the inclined surface 13 may guide the selecting guide member 17 to enter the shifting path 7b in the movement direction, to ensure a sufficient space through which the selecting guide member 17 may pass, whereby the control shaft 3 may be configured to move more smoothly for performing selecting and shifting.

The present invention may further include a controller 19 configured to operate the shifting actuator 1 for the gear shifting device for a vehicle to shift gears. In particular, for shifting, the controller 19 may be configured to determine a shifting path for the selecting guide member 17 to be guided into a shifting path 7b that corresponds to a desired gear stage from the current position by the selecting guides 15 and operate the shifting actuator 1 by calculating the stroke amount and the stroke direction of the shifting actuator 1 to follow the determined shifting path.

For example, referring to FIG. 3A, when shifting into the third gear stage from the second gear stage, the controller 19 may be configured to determine a shifting path in which the selecting guide member 17 in the second gear stage-shifting path 7b (at the first position) is moved to a predetermined position through the inlet (second position) of the first gear stage-shifting path 7b after passing through the selecting path 7a, may be guided to the selecting path (third position) between the third and fourth gear stage-shifting paths 7b by the lower selecting guide 15, and then may be guided into the third gear stage-shifting path 7b (fourth position) along the inclined surface 13 formed between the first and third gear stage-shifting paths 7b.

The forward and backward stroke amounts and the movement directions of the shifting actuator 1 may be adjusted to allow the selecting guide member 17 to move along the shifting path. In other words, it may be possible to shift into a desired gear while adjusting the stroke amount and movement direction of the shifting actuator required for the selecting guide member 17 to move from the first position to the second position, from the second position to the third position, and from the third position to the fourth position, using the shapes and arrangement of the selecting guides 15 and the shift guide 7 and the relative positions between the selecting guide member 17 and the selecting guides 15.

Further, when the position of the selecting guide member 17 is unclear, for example, in the early stage of starting an engine, the relative position of the selecting guide member 17 for shifting may be detected by the controller 19. Accordingly, referring to FIG. 6, the controller 19 may be configured to determine the center of the selecting path 7a by detecting the end of a first shifting path 7b through the selecting guide member 17 by operating the shifting actuator 1 to the end in a first direction and then detecting the end of a second shifting path 7b through the selecting guide member 17 by operating the shifting actuator 1 to the end in a second direction. For example, the controller 19 may be configured to determine the center of the selecting path 7a by calculating a middle point between the end of the first shifting path 7b and the second shifting path 7b.

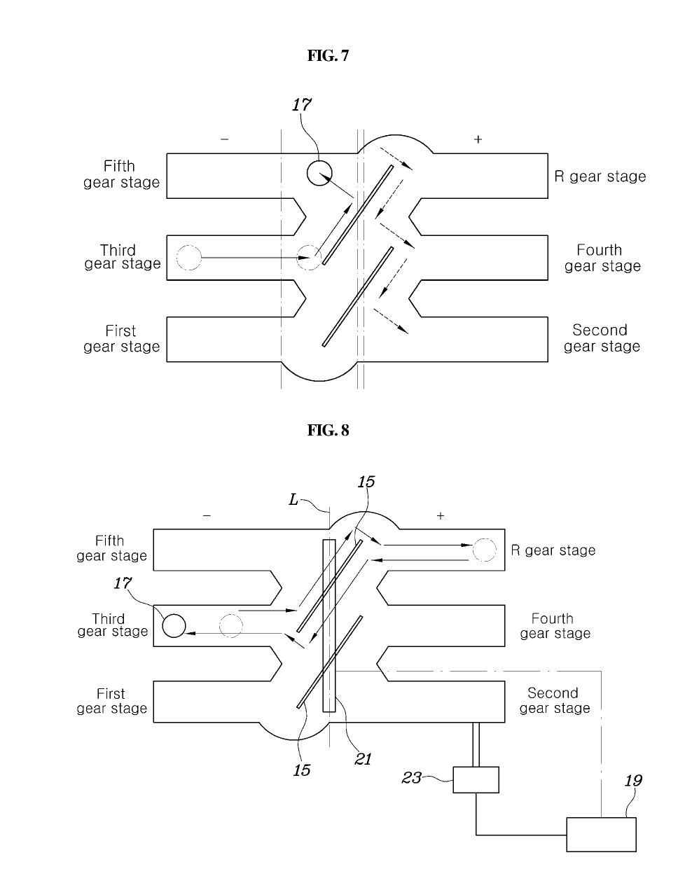

Referring to FIG. 7, the controller 19 may be configured to determine the position of the selecting guide member 17 in the selecting direction by detecting the end of the second shifting path 7b, moving the selecting guide member 17 toward the selecting guide 15 by operating the shifting actuator 1, and then detecting the end of the selecting path 7a by alternately operating the shifting actuator 1 in the first direction and the second direction. In other words, it may be possible to move the selecting guide member 17 proximate to the selecting guide 15 by detecting which shifting path 7 the selecting guide member 17 is currently positioned in, using two shifting paths 7b and the center of the selecting path 7a, and it may be possible to more accurately determine where the selecting guide member 17 is positioned by detecting the upper or lower end of the selecting path 7a by moving the selecting guide member 17 in a zigzag pattern. For various detection processes, the controller 19 may use a plurality of sensors mounted within the vehicle.

In particular, it may be possible to dispose the selecting guide member 17 at the inlet of a desired shifting path 7b in the early stage of starting an engine and thus, it may be possible to set the position of the selecting guide member 17 suitable for the driving conditions of a vehicle. Further, as another example for detecting the relative position of the selecting guide member 17, as shown in FIG. 8, a sensor 21 may be further disposed in the selecting path 7a, in which the controller 19 may be configured to determine the center of the selecting path 7a using a change in value output when the selecting guide member 17 passes through the sensor 21 in the selecting path 7a from the shifting paths 7b.

For example, when the sensor 21 is a stroke sensor, the sensor 21 may be disposed on the center line L of the selecting path 7a. Accordingly, when the selecting guide member 17 passes through the stroke sensor, an output value detected from a current or a voltage changes, and the controller 19 may be configured to determine how close the selecting guide member 17 is currently positioned to the center of the selecting path 7a from the change of the output value (e.g., determine a distance of the selecting guide member 17 to the center of the selecting path 7a). Further, when the sensor 21 is a hall sensor, the sensor 21 may be disposed at the center of a selecting guide 15, the controller may be configured to determine the center of the selecting path 7a from a change in signal output when the selecting guide member 17 passes through the hall sensor in a shifting path 7b.

In the exemplary embodiment shown in FIG. 8, a selecting position sensor 21 may be further disposed on the control shaft 3 to detect the position of the selecting guide member 17. The selecting position sensor 23 may be coupled to the control shaft 3 to move with the control shaft 3 moving for performing selecting. The controller 19 may be configured to determine the position of the selecting guide member 17 in the selecting direction based on a position signal from the selecting position sensor 23 that corresponds to the position of the control shaft 3 in the selecting direction. In other words, the controller 19 may be configured to determine the position of the selecting guide member 17 passing through the selecting path 7a or the selecting guides 15 (e.g., the center line L of the selecting path 7a), using the sensor 21, and accordingly, more accurately determine where the selecting guide member 17 is in the selecting path 7a using the selecting position sensor 23.

Shifting by the gear shifting device for a vehicle according to the present invention is described hereafter. FIG. 3A is a diagram illustrating the principle of shifting into the third gear stage from the second gear stage in a 5-speed AMT, in which when the shifting actuator 1 is operated backward with the selecting guide member 17 at the first position ‘a’ in the second gear stage-shifting path 7b, the selecting guide member 17 may come in contact with the lower side of the lower selecting guide 15. When the shifting actuator 1 continuously operates backward, the lower side of the selecting guide 15 guides the selecting guide member 17 in contact with the selecting guide member 17, the selecting guide 17 moves off the lower side of the selecting guide 15 and passes through the guide groove 9, and consequently, the selecting guide member 17 may be configured to move to the second position ‘b’ at the inlet of the first gear stage-shifting path 7b.

Thereafter, when the shifting actuator 1 is operated forward, the selecting guide member 17 may be brought in contact with the upper side of the lower selecting guide 15. When the shifting actuator 1 is continuously operated forward, the upper side of the selecting guide 15 guides the selecting guide member 17 in contact with selecting guide member 17, the selecting guide member 17 may be configured to move upward a predetermined distance to a third position ‘c’. The predetermined distance may be a distance that the selecting guide member 17 moves to enter the third gear stage-shifting path 7b by sliding on the inclined surface 13 between the first and third gear stages, in which the center of the selecting guide member 17 may be in the same line with the center of the second inclined surface 13b adjacent to the third gear stage-shifting path 7b, but may be changed, based on the shape and structure of the shift guide 7.

Thereafter, when the shifting actuator 1 is operated backward, the selecting guide member 17 may be brought in contact with the second inclined surface 13b between the first and third gear stage-shifting paths 7b. When the shifting actuator 1 is continuously operated backward, the selecting guide member 17 slides on the second inclined surface 13b and enters the third gear stage-shifting path 7b and the shift guide 7 is moved upward at a predetermine distance, selecting of the control shaft 3 to which the shift guide 7 is coupled may be performed. Thereafter, when the shifting actuator 1 is continuously operated backward, the selecting guide member 17 may be moved to a fourth position in the third gear stage-shifting path 7b and shifting into the third gear stage of the control shaft 3 may be completed.

FIG. 3B is a diagram illustrating the principle of shifting into a fourth gear stage from a third gear stage in a 5-speed AMT and FIG. 3C is a diagram illustrating the principle of shifting into a fifth gear stage from the fourth gear stage in a 5-speed AMT, in which desired shifting may be performed similarly by adjusting the operation and the operation direction of the shifting actuator 1. Further, FIG. 4A is a diagram illustrating the principle of shifting into a third gear stage from a first gear stage in a 7-speed DCT, FIG. 4B is a diagram illustrating the principle of shifting into a fifth gear stage from a third gear stage in a 7-speed DCT, and FIG. 4C is a diagram illustrating the principle of shifting into a fifth gear stage from a third gear stage in a 7-speed DCT, in which the shifting may be performed similarly by adjusting the operation and the operation direction of the shifting actuator 1.

As described above, the control shaft 3 may be moved vertically by vertically moving the shift guide 7 with the selecting guide 15 by operating the shifting actuator in the present invention. Accordingly, it may be possible to perform shifting and selecting of the control shaft 3 using the shifting actuator 1, and accordingly, the number of actuators may reduced, whereby the manufacturing cost and weight of the transmission may be decreased. Further, since only one actuator is used for shifting, noise due to operation of actuators may be decreased.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A gear shifting device for a vehicle, comprising:
a shift guide including selecting guides disposed between shifting paths for the selecting guides to diagonally face with a selecting path formed between the shifting paths; and
a selecting guide member disposed in a path made by the shift guide and configured to guide a control shaft in a selecting direction by being supported and guided by the selecting guides when the control shaft is moved in a shifting direction.

2. The device of claim 1, where the shift guide includes a selecting path formed in the selecting direction of the control shaft and a plurality of shifting paths arranged vertically at a side or at both sides of the selecting path.

3. The device of claim 2, wherein the selecting guides are formed in the shape of plates arranged at an angle across the selecting path, and both ends of the selecting guides are positioned at inlets of two shifting paths orthogonally facing with the selecting path.

4. The device of claim 3, wherein guide grooves through which the selecting guide member passes while being guided by the selecting guides are formed on inner sides of the shift guide.

5. The device of claim 4, wherein the guide grooves are formed in the shape of an arc inside outermost shifting paths facing ends of the selecting guides.

6. The device of claim 3, wherein sections are formed between shifting paths disposed proximate to each other in same directions to separate the shifting paths, and inclined surfaces inclined with respect to the shifting paths are formed at ends of the sections.

7. The device of claim 6, wherein the inclined surface protrudes toward a center of the selecting path at a middle portion of an end of a corresponding section and includes a first inclined surface and a second inclined surface inclined inward the shifting paths adjacent to the corresponding section, at both ends from the middle portion.

8. The device of claim 1, wherein the shift guide is fixed to cover the control shaft, and the selecting guide member is fixed at a position facing the control shaft to which the shift guide is fixed.

9. The device of claim 1, wherein the selecting guide member is fixed to the control shaft, and the shift guide is fixed along a rotational radius of the selecting guide member while facing the control shaft to which the selecting guide member is fixed.

10. The device of claim 1, further comprising:
a controller configured to determine a shifting path for the selecting guide member to be guided into a shifting path that corresponds to a desired gear stage from a current position by the selecting guides, and configured to adjust operation of the shifting actuator by calculating a stroke amount and a stroke direction of the shifting actuator to follow the determined shifting path.

11. The device of claim 10, wherein the controller is configured to determine a center of the selecting path by detecting an end of a first shifting path through the selecting guide member by operating the shifting actuator in a first direction and detecting an end of a second shifting path through the selecting guide member by operating the shifting actuator in a second direction.

12. The device of claim 11, wherein the controller is configured to determine the center of the selecting path by calculating a middle position between the end of the first shifting path and the second shifting path.

13. The device of claim 11, wherein the controller is configured to determine the position of the selecting guide member in the selecting direction by detecting the end of the second shifting path, moving the selecting guide member toward a selecting guide by operating the shifting actuator, and detecting an end of the selecting path by alternately operating the shifting actuator in the first direction and the second direction.

14. The device of claim 11, further comprising:
a sensor disposed in the selecting path,
wherein the controller is configured to determine the center of the selecting path using a change in value output when the selecting guide member passes through the sensor in the selecting path from the shifting paths.

15. The device of claim 11, further comprising:
a selecting position sensor disposed on the control shaft,
wherein the controller is configured to determine a position of the selecting guide member in the selecting direction based on a position signal from the selecting position sensor that corresponds to a position of the control shaft in the selecting direction.
